(19) United States
(12) Patent Application Publication
(10) Pub. No.: US 2023/0074525 A1
(43) Pub. Date: Mar. 9, 2023

(54) GRINDING OR POLISHING DEVICE AND METHOD FOR TREATING OF A WORKPIECE

(71) Applicant: TOLLENAAR INDUSTRIES B.V., Zwolle (NL)

(72) Inventor: Roland Wilhelm Anton TOLLENAAR, Zwolle (NL)

(21) Appl. No.: 17/904,409

(22) PCT Filed: Feb. 1, 2021
(86) PCT No.: PCT/NL2021/050061

§ 371 Date: Aug. 17, 2022

(30) Foreign Application Priority Data
Feb. 18, 2020 (NL) 2024933

(51) Int. Cl. B25J 11/00; B24B 27/00; B25J 13/08; B25J 17/02; B25J 19/02; B24B 49/10; B24B 49/12

(52) U.S. Cl. CPC B25J 11/0065; B24B 27/0038; B24B 27/0084; B25J 13/086; B25J 13/088; B25J 17/0208; B25J 19/021; B24B 49/10; B24B 49/12

(57) ABSTRACT

A grinding or polishing device and a method for treating a workpiece are provided. The grinding or polishing device includes a tool holder for holding a grinding or polishing tool and a mounting head for mounting the tool holder to a multi-axis manipulator. The tool holder is rotatable with respect to the mounting head about a pivot axis. The grinding or polishing device further includes a sensor for converting at least one parameter indicative of an angular position of the tool holder about the pivot axis into an output signal that can be used for determining a control signal for controlling the multi-axis manipulator.

### BACKGROUND

The invention relates to a grinding or polishing device and a method for treating a workpiece.

Grinding processes can be very labor intensive. Hence, attempts have been made to automate the grinding process, i.e. by mounting a grinding tool to a robotic manipulator and closely following the contour of a workpiece. This has proven difficult, as the exact position of the workpiece is unknown and, even if the position is known, the surface of the workpiece may have irregularities, i.e. as a result of burrs, that make it notoriously difficult to know the exact position of a surface. The known robotic manipulators are provided with complex impedance control means, i.e. vision, force sensors, torque sensors, etc.) to achieve a certain level of active compliance, i.e. the ability of the robotic manipulator to actively and adaptively control the path of the grinding tool relative to the workpiece.

### SUMMARY OF THE INVENTION

A disadvantage of the known grinding device is that the active impedance control is relatively complex and costly. Moreover, the active impedance control requires complex programming to obtain a reasonable level of compliance.

It is an object of the present invention to provide a grinding or polishing device and a method for grinding a contour of a workpiece, wherein the complexity and/or cost of the grinding or polishing device can be reduced.

According to a first aspect, the invention provides a grinding or polishing device for treating a workpiece, wherein the grinding or polishing device comprises a tool holder for holding a grinding or polishing tool and a mounting head for mounting the tool holder to a multi-axis manipulator, wherein the tool holder is rotatable with respect to the mounting head about a pivot axis, wherein the grinding or polishing device further comprises a sensor for converting at least one parameter indicative of an angular position of the tool holder about the pivot axis into an output signal that can be used for determining a control signal for controlling the multi-axis manipulator.

The output signal can be used to directly or indirectly determine the angular position of the tool holder, and the grinding or polishing tool held by said tool holder, relative to the mounting head. If the shape or contour of the workpiece is known, i.e. by vision technology, the information about the angular position of the tool holder for a certain position along the shape or contour of the workpiece can be used to determine the grinding or polishing angle of the grinding or polishing tool with respect to a particular surface of the workpiece and/or the relationship between the position of the multi-axis manipulator, the grinding or polishing angle and/or the angular position of the tool holder with respect to the workpiece or the mounting head. The output signal can be used to control the multi-axis manipulator to adjust the position of the grinding or polishing device as a whole relative to the workpiece, and thereby adjust or correct the grinding or polishing angle to a desired range or value.

In one embodiment the sensor is a rotary encoder for measuring the angular position of the tool holder about the pivot axis, wherein the output signal is representative of said angular position. By measuring the angular position of the tool holder directly, there is no need for other input, parameters and/or calculations to determine said angular position.

In an alternative embodiment the sensor is a proximity sensor for measuring a proximity of the tool holder with respect to the mounting head and/or the workpiece, wherein the output signal is representative of said proximity. The proximity sensor can act as a switch to indicate a zero position of the tool holder relative to the mounting head and/or to determine a relationship between the measured proximity and the angular position of the tool holder relative to the mounting head and/or the workpiece.

In a further alternative embodiment the sensor is an imaging device for capturing an image of the tool holder and/or the workpiece, wherein the output signal is representative of said image. The captured image can be used to determine the position of the workpiece relative to the multi-axis manipulator, the mounting head and/or the tool holder or the position of the tool holder relative to the multi-axis manipulator, the mounting head and/or the workpiece. This information can be used to indirectly determine a relationship between the relative position(s) and the angular position of the tool holder relative to the mounting head and/or the workpiece.

In an embodiment the grinding or polishing tool comprises a tool body and a grinding or polishing member that is rotatable with respect to the tool body about a rotation axis, wherein tool holder is arranged for holding the grinding or polishing tool such that the pivot axis extends perpendicular to the rotation axis. Hence, the rotation axis of the grinding or polishing member can be pivoted or tilted about the pivot axis to passively follow the contour of the workpiece at a certain grinding or polishing angle depending on the relative position of the grinding or polishing device as whole relative to the workpiece.

In a further embodiment the grinding or polishing device comprises a control unit that is operationally connected to the sensor for receiving the output signal from said sensor, wherein the control unit is arranged for sending the control signal to the multi-axis manipulator in response to the output signal from the sensor. Hence, the multi-axis manipulator can be controlled based on the output signal of the sensor.

Preferably, the multi-axis manipulator is arranged for positioning the grinding or polishing device as a whole with respect to the workpiece, wherein the control unit is arranged for sending the control signal to the multi-axis manipulator in response to the output signal from the sensor to adjust the position of the grinding or polishing device relative to the contour of the workpiece. By adjusting the position of the grinding or polishing device relative to the contour, the tool holder, and thus the grinding or polishing tool held by said tool holder, will automatically and/or passively be rotated or pivoted about the pivot axis, thus effectively changing, correcting and/or controlling the grinding or polishing angle.

More preferably, the control unit is arranged for controlling the position of the grinding or polishing device relative to the workpiece such that the grinding or polishing tool remains at a constant or substantially constant grinding or polishing angle to the workpiece. In other words, when the output signal of the sensor indicates that the angular position of the tool holder is changing relative to the mounting head along a part of the contour or during a stage of the grinding process where it should not change, i.e. due to unexpected or small variations in said contour, the position of the grinding or polishing device relative to the contour of the workpiece can be adjusted accordingly to compensate.

In a further embodiment the control unit is arranged for sending a control signal to the multi-axis manipulator to move said multi-axis manipulator in a translation relative to the workpiece, wherein the control unit is further arranged for determining, based on the output signal from the sensor, a relationship between translation of the multi-axis manipulator and the parameter indicative of the angular position of the tool holder about the pivot axis. Said relationship can be used to determine the appropriate control signal for the multi-axis manipulator to position the tool holder in a position that corresponds to a certain angular position in accordance with said relationship.

Preferably, the determination of the relationship comprises the use of a goniometric function with the angular position as one of the parameters. A goniometric function, in particular a trigonometric function, can be used to easily calculate the relationship between a translation of the multi-axis manipulator and the resulting angular position.

Additionally or alternatively, the determination of the relationship comprises the use of a computer model representative of the mounting head, the tool holder and/or the grinding or polishing tool. The computer model can be an accurate representation of the mounting head, the tool holder and/or the grinding or polishing tool, including, but not limited to, dimensions, shape and/or mechanical properties, such as joints, hinges and the degrees of freedom thereof.

In another embodiment the tool holder is freely or passively rotatable with respect to the mounting head about the pivot axis. Hence, the tool holder is able to passively follow the contour of the workpiece when allowed to do so by the positioning of the grinding or polishing device relative to the workpiece.

In another embodiment the pivot axis is horizontal or substantially horizontal. Hence, the tool holder can be pivoted in a vertical plane, perpendicular to said pivot axis.

In another embodiment the tool holder further comprises one or more biasing members for biasing the grinding or polishing tool to rotate about the pivot axis in a bias direction. The biasing can ensure that the grinding or polishing tool is pressed onto the workpiece with sufficient force.

In one particular embodiment thereof the grinding or polishing tool comprises a tool body and a grinding or polishing member that is rotatable with respect to the tool body about a rotation axis, wherein the one or more biasing members comprise one or more counter-weights, wherein the tool holder is arranged for holding the grinding or polishing tool such that the one or more counter-weights are at an opposite side of the pivot axis with respect to the rotation axis. The tool holder can thus be biased to tilt upwards with its grinding or polishing member towards the workpiece, i.e. when grinding or polishing a side surface of the workpiece.

In an alternative embodiment thereof the grinding or polishing tool comprises a tool body and a grinding or polishing member that is rotatable with respect to the tool body about a rotation axis, wherein the one or more biasing members comprise one or more weights, wherein the tool holder is arranged for holding the grinding or polishing tool such that the one or more weights are at the same side of the pivot axis as the rotation axis. The tool holder can thus be biased to tilt downwards with its grinding or polishing member towards the workpiece, i.e. when grinding or polishing a top surface of the workpiece or an edge of the workpiece at the transition from the side surface to the top surface.

In another embodiment the grinding or polishing device comprises the grinding or polishing tool. Preferably, the grinding or polishing tool is a right-angle grinder.

According to a second aspect, the invention provides a method for treating a workpiece using the grinding or polishing device according to any one of the aforementioned embodiments, wherein the method comprises the steps of converting at least one parameter indicative of the angular position of the tool holder about the pivot axis into the output signal and using said output signal for determining a control signal for controlling the multi-axis manipulator.

The method relates to the practical implementation of the grinding or polishing device according to the first aspect of the invention and therefore has the same technical advantages, which will not be repeated hereafter.

In one embodiment the output signal is representative of the angular position of the tool holder about the pivot axis.

In an alternative embodiment the output signal is representative of a proximity of the tool holder with respect to the mounting head and/or the workpiece.

In a further alternative embodiment the output signal is representative of an image of the tool holder and/or the workpiece.

In an embodiment the grinding or polishing tool comprises a tool body and a grinding or polishing member that is rotatable with respect to the tool body about a rotation axis, wherein the grinding or polishing tool is held by the tool holder such that the pivot axis extends perpendicular to the rotation axis.

In a further embodiment the method further comprises the step of controlling the multi-axis manipulator in response to the output signal from the sensor.

In another embodiment the method further comprises the step of controlling the multi-axis manipulator in response to the output signal from the sensor to adjust the position of the grinding or polishing device as a whole relative to the workpiece.

In another embodiment the method further comprises the step of controlling the position of the grinding or polishing device relative to the workpiece such that the grinding or polishing tool remains at a constant or substantially constant grinding or polishing angle to the workpiece.

In one particular embodiment thereof the workpiece has a side surface, wherein the grinding or polishing angle is kept constant at zero or substantially zero degrees when grinding or polishing the side surface. Hence, the grinding surface of the grinding or polishing member can be kept parallel or substantially parallel to the side surface.

In an alternative embodiment thereof the workpiece has a side surface, a top surface and an edge at the transition from the side surface to the top surface, wherein the grinding or polishing angle is kept in a range of zero to ten degrees, preferably zero to five degrees, when grinding or polishing the edge and/or the top surface. Hence, the grinding or polishing member can be made to contact the edge and/or the top surface with its outer tip only.

In a further embodiment the multi-axis manipulator is moved in a translation relative to the workpiece, wherein, based on the output signal from the sensor, a relationship is determined between translation of the multi-axis manipulator and the parameter indicative of the angular position of the tool holder about the pivot axis.

Preferably, the determination of the relationship comprises the use of a goniometric function with the angular position as one of the parameters.

Additionally or alternatively, the determination of the relationship comprises the use of a computer model representative of the mounting head, the tool holder and/or the grinding or polishing tool.

In another embodiment the tool holder is freely or passively rotated with respect to the mounting head about the pivot axis.

In another embodiment the pivot axis is horizontal or substantially horizontal during the step(s) of the method.

In another embodiment the grinding or polishing tool is biased to rotate about the pivot axis in a bias direction.

In one particular embodiment thereof the grinding or polishing tool comprises a tool body and a grinding or polishing member that is rotatable with respect to the tool body about a rotation axis, wherein the grinding or polishing tool is biased to move in an upward rotation about the pivot axis at the same side of the pivot axis as the rotation axis.

In an alternative embodiment thereof the grinding or polishing tool comprises a tool body and a grinding or polishing member that is rotatable with respect to the tool body about a rotation axis, wherein the grinding or polishing tool is biased to move in an upward rotation about the pivot axis at an opposite side of the pivot axis with respect to the rotation axis.

In another embodiment the grinding or polishing tool is a right-angle grinder.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIG. 1 shows a side view of a grinding device according to a first exemplary embodiment of the invention;

FIG. 2 shows a side view of an alternative grinding device according to a second exemplary embodiment of the invention;

FIG. 3 shows a side view of a further alternative grinding device according to a third exemplary embodiment of the invention;

FIGS. 4-6 show side views of the grinding device according to FIG. 1 during the steps of a method for grinding a side surface of a workpiece;

FIGS. 7 and 8 show side views of the grinding device according to FIG. 1 during the steps of a method for grinding an edge and/or a top surface of a workpiece;

FIG. 9 shows a side view of a further alternative grinding device according to a fourth exemplary embodiment of the invention; and

FIG. 10 shows a side view of a further alternative grinding device according to a fifth exemplary embodiment of the invention.

### DETAILED DESCRIPTION OF THE INVENTION

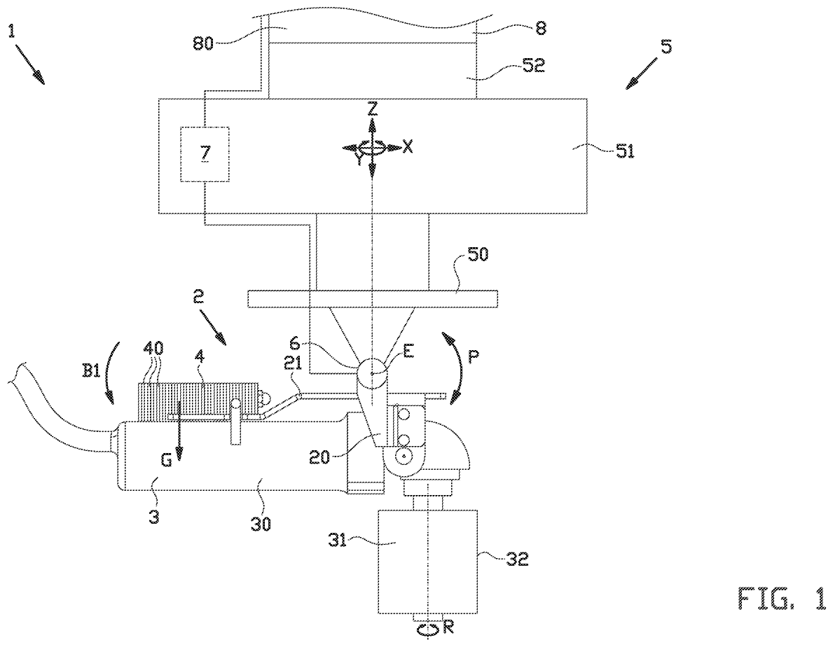

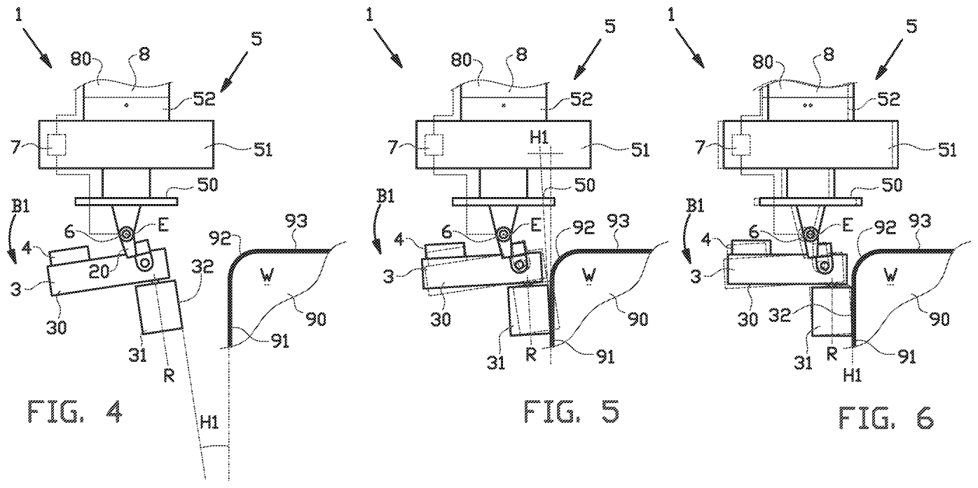

FIG. 1 shows a surface treatment device, in particular a grinding device 1, according to a first exemplary embodiment of the invention. The grinding device 1 is used for grinding a contour or along a contour of a workpiece W, as shown in FIGS. 4-6.

The grinding device 1 comprises a tool holder 2 for holding a grinding tool 3. The grinding tool 3 comprises a tool body 30 and a grinding member 31 that is rotatable with respect to the tool body 30 about a rotation axis R. In this exemplary embodiment, the grinding tool 3 is a right-angle grinder. The grinding member 31 is a grinding roller, i.e. a cylindrical grinding member with a relatively long circumferential grinding surface 32 considered in a direction parallel to the rotation axis R. Different grinding tools 3, 103, 203 and/or grinding members 31, 131, 231 may be fitted, as shown by way of example in FIGS. 1, 2 and 3. The alternative grinding tools 103, 203 and their application will be discussed later in this description.

The grinding device 1 further comprises a mounting head 5 for mounting the holder 2 to a multi-axis manipulator 8. The multi-axis manipulator 8 may for example be a robotic manipulator or a robot arm. In this exemplary embodiment, the multi-axis manipulator 8 has at least three degrees of freedom; a lateral translation X, a vertical translation Z and a yaw Y about a vertical axis. Preferably, the multi-axis manipulator 8 has more than three degrees of freedom.

The mounting head 5 comprises a mounting plate or a mounting flange 50 for connection to the tool holder 2, a housing 51 for accommodating various types of electronic equipment, like sensors, processors, memory, connectors and the like, and a gripper member 52 for releasable connection to a corresponding gripper member 80 of the multi-axis manipulator 8.

The tool holder 2 is rotatable with respect to the mounting head 5 about a pivot axis E. In particular, the tool holder 2 is freely or passively rotatable with respect to the mounting head 5 about the pivot axis E, as shown schematically in FIG. 1 with arrow P. During the grinding of the contour of the workpiece W, said pivot axis E extends horizontally or substantially horizontally. Consequently, the tool holder 2 and the grinding tool 3 held by said tool holder 2 can be pivoted or tilted about the pivot axis E in a vertical or substantially vertical plane. Preferably, the rotation axis R of the grinding member 31 extends within or parallel to said vertical plane.

As shown in FIG. 1, the tool holder 2 is arranged for holding the grinding tool 3 such that the pivot axis E extends perpendicular to the rotation axis R. In particular, the tool holder 2 comprises a first frame member 20 for holding the tool body 30 at a position relatively close to the grinding member 31 and/or the pivot axis E and a second frame member 21 that extends towards the rear end of the tool body 30 with respect to the grinding member 31 for holding the tool body 30 at or near said rear end. The grinding tool 3 is connected to the frame members 20, 21 through suitable fasteners or clamps. Hence, the grinding tool 3 can be held reliably and/or securely by said tool holder 2.

It will be clear that the tool holder 2 may be used for holding another surface treatment tool, i.e. a polishing tool, a sanding tool or the like (not shown) with a corresponding polishing member. Hence, the grinding device could be renamed as a polishing device, or a surface treatment device in general.

As shown in FIG. 1, the tool holder 2 further comprises one or more biasing members 4 for biasing the tool holder 2 and/or the grinding tool 3 to rotate about the pivot axis E in a first bias direction B1. In this exemplary embodiment, the one or more biasing members 4 are formed by one or more counter-weights 40 that exert or generate a gravitational force G on the tool holder 2 and/or the grinding tool 3. The tool holder 2 is arranged for holding the grinding tool 3 such that the one or more counter-weights 40 are at an opposite side of the pivot axis E with respect to the rotation axis R. Hence, the grinding tool 3 is biased to tilt or pivot downwards at the rear end of its tool body 30, in other words biasing the grinding member 31 at the front to tilt upwards about the pivot axis E.

The grinding device 1 further comprises a sensor, in particular a rotary encoder 6, for converting at least one parameter indicative of an angular position of the tool holder 2 about the pivot axis E into an output signal that can be used for determining a control signal for controlling the multi-axis manipulator 8. In this particular example, the rotary encoder 6 is arranged for directly converting an angular position of the tool holder 2 about the pivot axis E into an output signal representative of said angular position. The grinding device 1 comprises a control unit 7 that is operationally connected to the rotary encoder 6 for receiving the output signal from said rotary encoder 6. The control unit 7 may be accommodated on or in the housing 51 of the mounting head 5. Alternatively, the control unit 7 may be provided in or on the multi-axis manipulator 8 or even remotely, i.e. in a control room spaced apart from the grinding device 1 and the multi-axis manipulator 8. For the purpose of this invention, such a control unit 7 is still considered a part of the grinding device 1, either directly or indirectly.

The control unit 7 is arranged for sending a control signal to the multi-axis manipulator 8 in response to the output signal received from the rotary encoder 6. In other words, the control unit 7 is able to receive and store the output signal from the rotary encoder 6, and then convert said output signal into a control signal for the multi-axis manipulator 8.

As shown in FIGS. 4-6, the multi-axis manipulator 8 is arranged for positioning the grinding device 1 as a whole with respect to the contour of the workpiece W. In this exemplary embodiment, the workpiece W has a side surface 91, a top surface 93 and an edge 92 at the transition from the side surface 91 to the top surface 93. The side surface 91, the edge 92 and the top surface 93 together form the contour of the workpiece W. In this particular case, the side surface 91 extends vertically or substantially vertically and the top surface 93 extends horizontally or substantially horizontally.

The control unit 7 is arranged for sending the control signal to the multi-axis manipulator 8 in response to the output signal from the rotary encoder 6 to adjust the position of the grinding device 1 relative to the contour of the workpiece W. In particular, the position of the grinding device 1 is controlled in such a way that, once the grinding tool 1 is positioned correctly with respect to the workpiece W, the grinding tool 1 remains at a constant or substantially constant grinding angle H1 to the workpiece W when following the contour of the workpiece W.

In the example as shown in FIGS. 4-6, the grinding tool 3 is made to approach the workpiece W to perform a grinding operation or process on the side surface 91. In the situation as shown in FIG. 4, the grinding device 1 is still in a position in which the grinding tool 3 is spaced apart from the workpiece W. Hence, the grinding tool 3 is biased by the counter-weights 40 in the first bias direction B1 until it arrives in an equilibrium position, tilted with its grinding member 31 upwards with respect to the workpiece W. Note that in this position, the grinding angle H1, defined as the angle between the grinding surface 32 of the grinding member 31 and the side surface 91 of the workpiece W, is considerable. As the grinding device 1 is moved closer to the workpiece W by the multi-axis manipulator 8, the grinding member 31 will contact or abut the side surface 91 of the workpiece W and—as a result of said contact—will start to tilt or pivot about the pivot axis E in a direction against the bias of the counter-weights 40. The grinding angle H1 decreases and the grinding surface 32 starts to become aligned, or parallel, with the side surface 91 of the workpiece W.

FIG. 5 may represent a situation in which the multi-axis manipulator 8 has reached a position in which the grinding tool 31 should be in the correct position relative to the side surface 91 of the workpiece W, at least based on the knowledge of the contour of the workpiece W. However, it can be observed that in FIG. 5, the grinding surface 32 is still at a small grinding angle H1 to the side surface 91. The output signal from the rotary encoder 6 will reflect this position. Hence, the control unit 7 may send a control signal to the multi-axis manipulator 8 to further adjust or correct the position of the grinding device 1 relative to workpiece W until the output signal from the rotary encoder 6 indicates that the grinding angle H1 is correct, as shown in FIG. 6 in dashed lines (incorrect position) and solid lines (corrected or adjusted position).

The rotary encoder 6, the control unit 7 and the multi-axis manipulator 8 may continue to operate in the aforementioned feedback loop during the grinding operation or process to ensure that—as long as the grinding tool 3 is grinding the side surface 92 of the workpiece W—the grinding angle H1 remains constant or substantially constant. Hence, the relative position of the grinding device 1 with respect to the workpiece W can be continuously corrected to compensate for irregularities or deviations of the contour of the workpiece W from the expected contour. Consequently, an effective compliance between the multi-axis manipulator 8 and the workpiece W can be obtained.

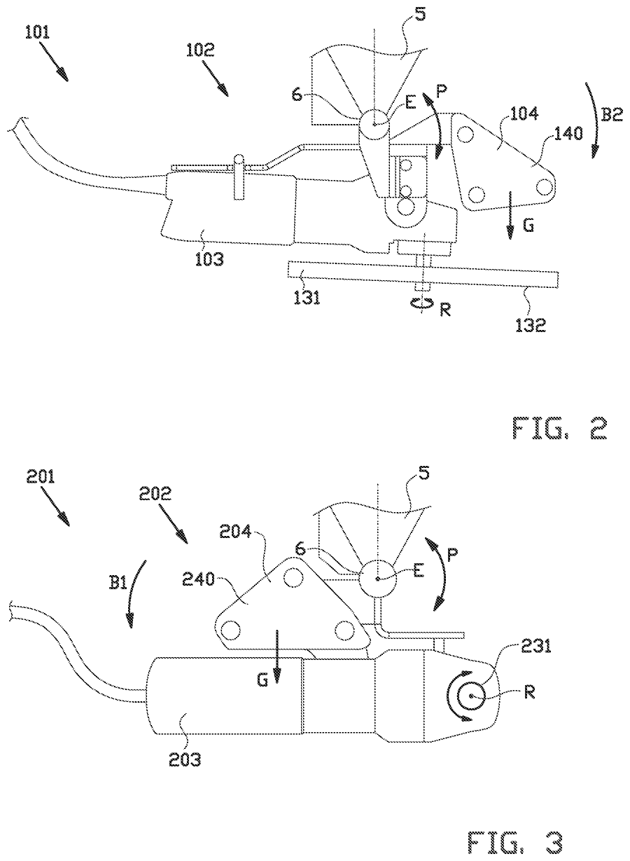

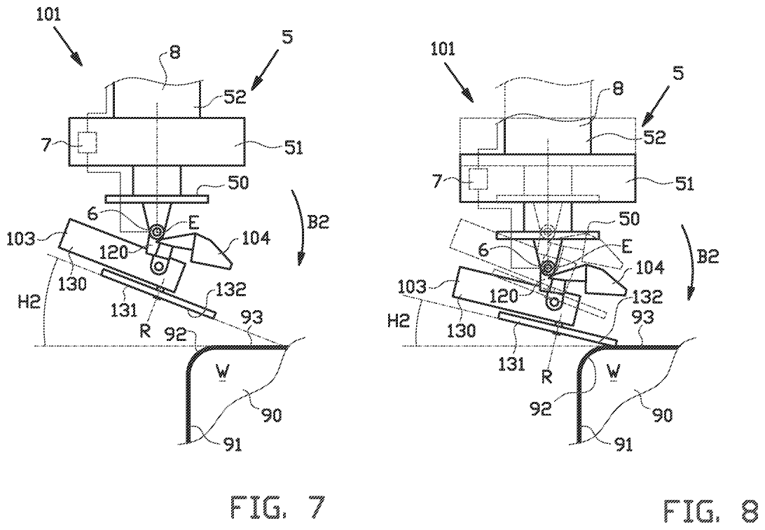

FIG. 2 shows an alternative grinding device 101 according to a second exemplary embodiment of the invention, that differs from the previously discussed grinding device 1 in that its tool holder 102 is arranged for holding a grinding tool 103 with a disc-shaped grinding member 131. Said grinding tool 103 is used to grind the edge 92 or the top surface 93 of a workpiece W at a relatively small, oblique grinding angle H2, as shown by way of example in FIGS. 7 and 8.

In the situation as shown in FIG. 7, the planar grinding surface 132 of the grinding member 103 is at a relatively large oblique grinding angle H2 to the top surface 93 of the workpiece W. This is reflected in the output signal of the rotary encoder 6. As shown in FIG. 8, an appropriate control signal is send by the control unit 7 to the multi-axis manipulator 8 to cause the alternative grinding device 101 to move further down towards or onto the top surface 93, thereby reducing the grinding angle H2 to a value or a range that is within the desired range for grinding the top surface 93.

The alternative grinding device 101 further differs from the previously discussed grinding device 1 in that the one or more biasing members 104 are located at the same side of the pivot axis E as the rotation axis R of the grinding member 131. Hence, the one or more biasing members 104 contribute to the downward tilt or pivot of the grinding tool 103 at the side of the grinding member 131. In this exemplary embodiment, the one or more biasing members 104 are formed as weights 140.

FIG. 3 shows a further alternative grinding device 201 according to a third exemplary embodiment of the invention that differs from the aforementioned grinding devices 1, 101 in that its tool holder 202 is arranged for holding a grinding tool 203 with a relatively small cylindrical grinding stone 231. Typically, said grinding tool 203 is used to manually grind hard to reach places, such as cavities, ridges and corners in the workpiece W. Note that the grinding tool 203 is mounted in the tool holder 203 in sideways orientation, i.e. with the rotation axis R of the grinding member 231 parallel or substantially parallel to the pivot axis E. Although in this embodiment, a pivoting movement or rotation P about the pivot axis E has no effect on the grinding angle, the feedback from the rotary encoder 6 can still be used to determine whether the grinding stone 231 is in the correct or expected position relative to the contour of the workpiece W.

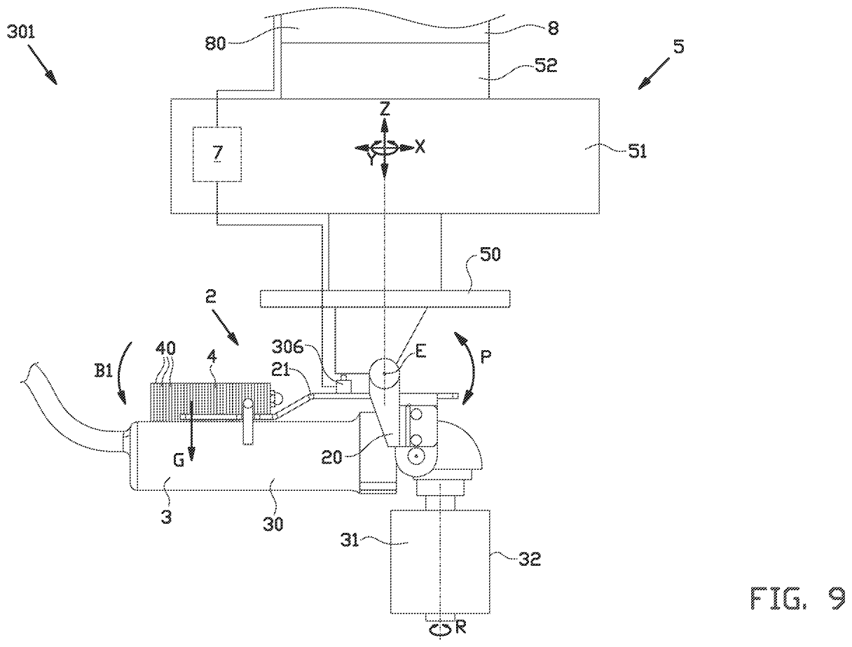

FIG. 9 shows a further alternative grinding device 301 according to a fourth exemplary embodiment of the invention that differs from the previously discussed grinding devices 1, 101, 201 in that its sensor is a proximity sensor 306 for measuring a proximity of the tool holder 2 with respect to the mounting head 5 and/or the workpiece W. Hence, the output signal is representative of said proximity. The proximity sensor 306 can act as a switch to indicate a zero position of the tool holder 2 relative to the mounting head 5 and/or to determine a relationship between the measured proximity and the angular position of the tool holder 2 relative to the mounting head 5 and/or the workpiece W.

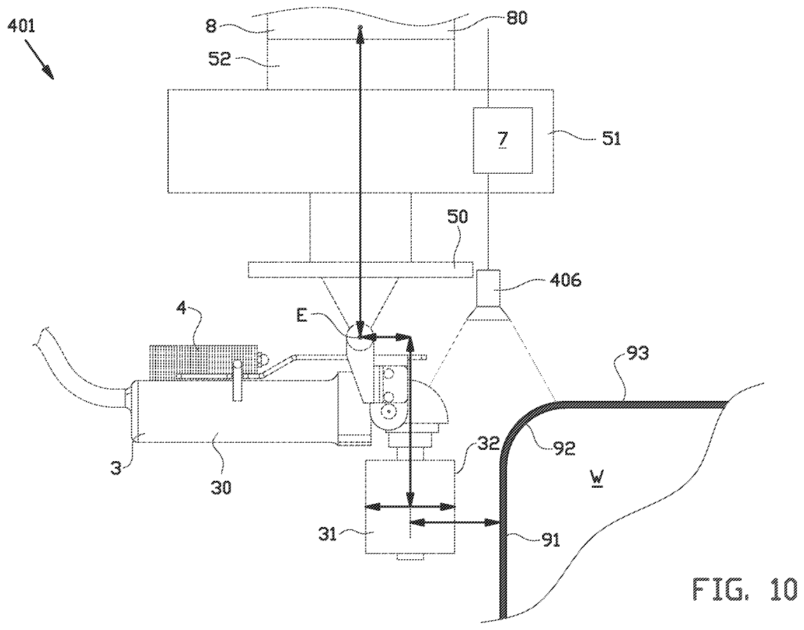

FIG. 10 shows a further alternative grinding device 401 according to a fifth exemplary embodiment of the invention that differs from the previously discussed grinding devices 1, 101, 201, 301 in that its sensor is a an imaging device 406 for capturing an image of the tool holder 2 and/or the workpiece W. Hence, the output signal is representative of said image. The captured image can be used to determine the position of the workpiece W relative to the multi-axis manipulator 8, the mounting head 5 and/or the tool holder 2 or the position of the tool holder 2 relative to the multi-axis manipulator 8, the mounting head 3 and/or the workpiece W. This information can be used to indirectly determine a relationship between the relative position(s) and the angular position of the tool holder 2 relative to the mounting head 5 and/or the workpiece W.

In both of these embodiment, the control unit 7 is arranged for determining, based on the output signal from the sensor 306, 406, a relationship between translation of the multi-axis manipulator 8 and the parameter directly or indirectly indicative of the angular position of the tool holder 2 about the pivot axis E. Said relationship can be used to determine the appropriate control signal for the multi-axis manipulator 8 to position the tool holder 2 in a position that corresponds to a certain angular position in accordance with said relationship.

Preferably, the determination of the relationship comprises the use of a goniometric function with the angular position as one of the parameters. A goniometric function, in particular a trigonometric function, can be used to easily calculate the relationship between a translation of the multi-axis manipulator 8 and the resulting angular position.

As shown in FIG. 10, the determination of the relationship may additionally or alternatively comprise the use of a computer model representative of the mounting head 5, the tool holder 2 and/or the grinding tool 3. The computer model can be an accurate representation of the mounting head 5, the tool holder 2 and/or the grinding tool 3, including, but not limited to, dimensions, shape and/or mechanical properties, such as joints, hinges and the degrees of freedom thereof.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

1-37. (canceled)

38. A grinding or polishing device for treating a workpiece,
wherein the grinding or polishing device comprises a tool holder for holding a grinding or polishing tool and a mounting head for mounting the tool holder to a multi-axis manipulator,
wherein the tool holder is rotatable with respect to the mounting head about a pivot axis,
wherein the grinding or polishing device further comprises a sensor for converting at least one parameter indicative of an angular position of the tool holder about the pivot axis into an output signal that can be used for determining a control signal for controlling the multi-axis manipulator.

39. The grinding or polishing device according to claim 38, wherein the sensor is a rotary encoder for measuring the angular position of the tool holder about the pivot axis,
wherein the output signal is representative of said angular position.

40. The grinding or polishing device according to claim 38, wherein the sensor is a proximity sensor for measuring a proximity of the tool holder with respect to the mounting head or the workpiece,
wherein the output signal is representative of said proximity.

41. The grinding or polishing device according to claim 38, wherein the sensor is an imaging device for capturing an image of the tool holder or the workpiece,
wherein the output signal is representative of said image.

42. The grinding or polishing device according to claim 38, wherein the grinding or polishing tool comprises a tool body and a grinding or polishing member that is rotatable with respect to the tool body about a rotation axis,
wherein the tool holder is arranged for holding the grinding or polishing tool such that the pivot axis extends perpendicular to the rotation axis.

43. The grinding or polishing device according to claim 38, wherein the grinding or polishing device comprises a control unit that is operationally connected to the sensor for receiving the output signal from said sensor,
wherein the control unit is arranged for sending the control signal to the multi-axis manipulator in response to the output signal from the sensor.

44. The grinding or polishing device according to claim 43, wherein the multi-axis manipulator is arranged for positioning the grinding or polishing device as a whole with respect to the workpiece,
wherein the control unit is arranged for sending the control signal to the multi-axis manipulator in response to the output signal from the sensor to adjust the position of the grinding or polishing device relative to the workpiece.

45. The grinding or polishing device according to claim 44, wherein the control unit is arranged for controlling the position of the grinding or polishing device relative to the workpiece such that the grinding or polishing tool remains at a constant grinding or polishing angle to the workpiece.

46. The grinding or polishing device according to claim 43, wherein the control unit is arranged for sending a control signal to the multi-axis manipulator to move said multi-axis manipulator in a translation relative to the workpiece,
wherein the control unit is further arranged for determining, based on the output signal from the sensor, a relationship between translation of the multi-axis manipulator and the parameter indicative of the angular position of the tool holder about the pivot axis.

47. The grinding or polishing device according to claim 46, wherein the determination of the relationship comprises the use of a goniometric function with the angular position as one of the parameters.

48. The grinding or polishing device according to claim 46, wherein the determination of the relationship comprises the use of a computer model representative of the mounting head, the tool holder or the grinding or polishing tool.

49. The grinding or polishing device according to claim 38, wherein the tool holder is freely or passively rotatable with respect to the mounting head about the pivot axis.

50. The grinding or polishing device according to claim 38, wherein the pivot axis is horizontal.

51. The grinding or polishing device according to claim 38, wherein the tool holder further comprises one or more biasing members for biasing the grinding or polishing tool to rotate about the pivot axis in a bias direction.

52. The grinding or polishing device according to claim 51, wherein the grinding or polishing tool comprises a tool body and a grinding or polishing member that is rotatable with respect to the tool body about a rotation axis,
wherein the one or more biasing members comprise one or more counter-weights,
wherein the tool holder is arranged for holding the grinding or polishing tool such that the one or more counter-weights are at an opposite side of the pivot axis with respect to the rotation axis.

53. The grinding or polishing device according to claim 51, wherein the grinding or polishing tool comprises a tool body and a grinding or polishing member that is rotatable with respect to the tool body about a rotation axis,
wherein the one or more biasing members comprise one or more weights,
wherein the tool holder is arranged for holding the grinding or polishing tool such that the one or more weights are at the same side of the pivot axis as the rotation axis.

54. The grinding or polishing device according to claim 38, wherein the grinding or polishing device comprises the grinding or polishing tool.

55. The grinding or polishing device according to claim 54, wherein the grinding or polishing tool is a right-angle grinder.

56. A method for treating a workpiece using the grinding or polishing device according to claim 38,
wherein the method comprises the steps of converting at least one parameter indicative of the angular position of the tool holder about the pivot axis into the output signal and using said output signal for determining a control signal for controlling the multi-axis manipulator.

57. The method according to claim 56, wherein the method further comprises the step of controlling the multi-axis manipulator in response to the output signal from the sensor.
